(19) United States
(12) Patent Application Publication
(10) Pub. No.: US 2025/0245793 A1
(43) Pub. Date: Jul. 31, 2025

(54) ELECTRONIC DEVICE AND METHOD FOR IMPROVING DIGITAL BOKEH PERFORMANCE

(71) Applicant: SAMSUNG ELECTRONICS CO., LTD., Suwon-si (KR)

(72) Inventors: Sungshik KOH, Suwon-si (KR); Sangjum YU, Suwon-si (KR); Jonghoon WON, Suwon-si (KR); Kihuk LEE, Suwon-si (KR)

(73) Assignee: SAMSUNG ELECTRONICS CO., LTD., Suwon-si (KR)

(21) Appl. No.: 19/183,035

(22) Filed: Apr. 18, 2025

Related U.S. Application Data
(63) Continuation of application No. PCT/KR2023/014712, filed on Sep. 25, 2023.

(30) Foreign Application Priority Data
Oct. 18, 2022 (KR) 10-2022-0134500
Dec. 8, 2022 (KR) 10-2022-0171024

(51) Int. Cl. G06T 5/70; G06T 3/40; G06T 5/50; G06T 7/194; G06T 7/62; G06V 10/25

(52) U.S. Cl. CPC G06T 5/70; G06T 3/40; G06T 5/50; G06T 7/194; G06T 7/62; G06V 10/25; G06T 2207/20221

(57) ABSTRACT

An electronic device includes: a first camera; a second camera having a second focal length that is different from that of the first camera; and at least one processor configured to: identify, within an input image obtained through the first camera, an unclassified region; obtain, through the second camera, a plurality of zoom images based on a zoom ratio of the second camera identified, by the at least one processor, to capture the unclassified region; identify a masking portion corresponding to an object, based on the plurality of zoom images; identify a background region image of the input image by determining the unclassified region as one of the background region and the object region based on the input image and the masking portion; and display an output image based on a blur processing for the background region image.

### CROSS-REFERENCE TO RELATED APPLICATIONS

This application is a by-pass continuation application of International Application No. PCT/KR2023/014712, filed on Sep. 25, 2023, which is based on and claims priority to Korean Patent Application No. 10-2022-0134500, filed on Oct. 18, 2022, and Korean Patent Application No. 10-2022-0171024, filed on Dec. 8, 2022, in the Korean Intellectual Property Office, the disclosures of which are incorporated by reference herein their entireties.

### BACKGROUND

### 1. Field

The disclosure relates to an electronic device and a method for improving digital bokeh performance.

### 2. Description of Related Art

According to miniaturization of a smartphone, a thickness of a camera module has decreased. Importance of digital bokeh technology has increased due to the decrease in the thickness of the camera module. “Digital bokeh” is a technology that synthesizes a blur-processed background region image with an object region image corresponding to a subject by separating the subject and background.

The above-described information may be provided as a related art for the purpose of helping to understand the present disclosure. No claim or determination is raised as to whether any of the above-described information may be applied as a prior art related to the present disclosure.

### SUMMARY

According to an aspect of the disclosure, an electronic device includes: a first camera having a first focal length; a second camera having a second focal length that is different from the first focal length of the first camera; a display; and at least one processor operatively connected to the first camera, the second camera, and the display and configured to: identify, within an input image obtained through the first camera, an unclassified region that is neither identified as an object region nor as a background region; obtain, through the second camera, a plurality of zoom images based on a zoom ratio of the second camera identified, by the at least one processor, to include the unclassified region; identify a masking portion corresponding to an object, based on the plurality of zoom images; identify a background region image of the input image by determining the unclassified region as one of the background region and the object region based on the input image and the masking portion; and display, through the display, an output image based on a blur processing for the background region image.

The at least one processor may be further configured to obtain the plurality of zoom images by obtaining, through the second camera, a zoom image for each of a plurality of ratios from a ratio of a starting point up to the zoom ratio.

The at least one processor may be further configured to identify the masking portion by: identifying a size of the object within a first zoom image, among the plurality of zoom images, corresponding to the zoom ratio, and performing scaling on each of second zoom images that are different from the first zoom image, among the plurality of zoom images, based on the size of the object in the first zoom image.

The at least one processor may be further configured to identify the masking portion by: generating a plurality of masking candidate images, based on the first zoom image and the scaled second zoom images, generating a masking image in which the unclassified region is not included, based on the plurality of masking candidate images, and identifying the masking portion corresponding to the object from the masking image.

Each of the plurality of masking candidate images may be generated through a pixel-to-pixel exclusive OR (XOR) operation performed on each of the plurality of zoom images.

The masking image may be generated based on an average value of pixels of each of the plurality of masking candidate images.

The at least one processor may be further configured to identify the background region image by: in a first case that the unclassified region of the input image overlaps with the masking portion, determining the unclassified region of the input image as the object region, and in a second case that the unclassified region of the input image does not overlap with the masking portion, determining the unclassified region of the input image as the background region.

The output image may be generated by combining the background region image subjected to the blur processing with an object region image corresponding to the masking portion.

Each of the plurality of zoom images may have a different depth and ratio.

The first camera may be a camera without continuous zoom, and wherein the second camera may be a telephoto camera having the continuous zoom.

According to an aspect of the disclosure, a method performed by an electronic device, the method including: identifying, within an input image obtained through a first camera of the electronic device, an unclassified region that is neither identified as an object region nor as a background region; obtaining, through a second camera of the electronic device, a plurality of zoom images based on a zoom ratio of the second camera identified to include the unclassified region; identifying a masking portion corresponding to an object, based on the plurality of zoom images; identifying a background region image of the input image by determining the unclassified region as one of the background region and the object region, based on the input image and the masking portion; and displaying, through a display of the electronic device, an output image based on a blur processing for the background region image.

The obtaining the plurality of zoom images may include obtaining, through the second camera, a zoom image for each of a plurality of ratios from a ratio of a starting point to the zoom ratio.

The identifying the masking portion may include: identifying a size of the object within a first zoom image, among the plurality of zoom images, corresponding to the zoom ratio, and performing scaling on each of second zoom images that are different from the first zoom image, among the plurality of zoom images, based on the size of the object in the first zoom image.

The identifying the masking portion may include: generating a plurality of masking candidate images, based on the first zoom image and the scaled second zoom images, generating a masking image in which the unclassified region is not included, based on the plurality of masking candidate images, and identifying the masking portion corresponding to the object from the masking image.

Each of the plurality of masking candidate images may be generated through a pixel-to-pixel exclusive OR (XOR) operation performed on each of the plurality of zoom images.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment, according to embodiments;

FIG. 2 is a flowchart of operations of an electronic device for classifying a background region and an object region, according to embodiments;

FIG. 3 illustrates an example of a change in a background region according to a zoom operation of a camera, according to embodiments;

FIG. 4 illustrates an example of identification of an object region according to a depth, according to embodiments;

FIG. 5 illustrates an example of a depth according to a zoom operation of a camera, according to embodiments;

FIG. 6 illustrates an example of classifying an object region by discontinuous-zoom and classifying a region by continuous-zoom, according to embodiments;

FIG. 7 illustrates an example of scaling performed based on a size of an object;

FIG. 8 illustrates an example of a method of generating a masking image based on a plurality of zoom images;

FIG. 9 illustrates an example of a method of generating an output image based on a plurality of zoom images;

FIG. 10 illustrates a flow of operations of an electronic device for generating an output image to which digital bokeh is applied through continuous-zoom; and

FIG. 11 illustrates a flow of operations of an electronic device for performing digital bokeh.

### DETAILED DESCRIPTION

Terms used in the present disclosure are used only to describe a specific embodiment, and may not be intended to limit a range of another embodiment. A singular expression may include a plural expression unless the context clearly means otherwise. Terms used herein, including a technical or a scientific term, may have the same meaning as those generally understood by a person with ordinary skill in the art described in the present disclosure. Among the terms used in the present disclosure, terms defined in a general dictionary may be interpreted as identical or similar meaning to the contextual meaning of the relevant technology and are not interpreted as ideal or excessively formal meaning unless explicitly defined in the present disclosure. In some cases, even terms defined in the present disclosure may not be interpreted to exclude embodiments of the present disclosure.

In one or more embodiments of the present disclosure described below, a hardware approach will be described as an example. However, since one or more embodiments of the present disclosure include technology that may use both hardware and software, the one or more embodiments of the present disclosure do not exclude a software-based approach.

Terms referring to object area (e.g., object area, region of interest, object region image, object image), terms referring to background region (e.g., background region, background region image, image part of background, background image), terms referring to scaling (e.g., scaling, size calibration), terms referring to zoom magnification (e.g., zoom magnification, magnification), terms referring to a specified value (e.g., reference value, threshold value), and the like, used in the following description are exemplified for convenience of explanation. Therefore, the present disclosure is not limited to terms to be described below, and another term having an equivalent technical meaning may be used. In addition, a term such as ‘ . . . unit,’ . . . device, ‘ . . . object’, and ‘ . . . structure’, and the like used below may mean at least one shape structure or may mean a unit processing a function.

In addition, in the present disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B).

Prior to describing embodiments of the present disclosure, terms necessary to describe operations of an electronic device according to embodiments are defined.

An object region may mean a portion of an image corresponding to a subject. A background region may be a portion of the image corresponding to a background. The background region may be the portion of the image corresponding to the background excluding the subject, which is farther than the subject. An unclassified region may be a portion of the image in which classification of whether it is the background region or the object region, with respect to at least one processor, is unclear. A depth of an image may be a distance range at which the subject is perceived to be in focus when placed at a corresponding distance. The distance range may be between a front depth distance and a rear depth distance. The front depth distance may be shorter than the rear depth distance. The forward depth distance may be the shortest distance at which the subject is in focus when placed. The rear depth distance may be the farthest distance at which the subject is in focus when placed.

Hereinafter, one or more embodiments disclosed in the present document will be described with reference to the accompanying drawings. For convenience of description, components illustrated in the drawings may be exaggerated or reduced in size, but are not necessarily limited to those illustrated in the present document.

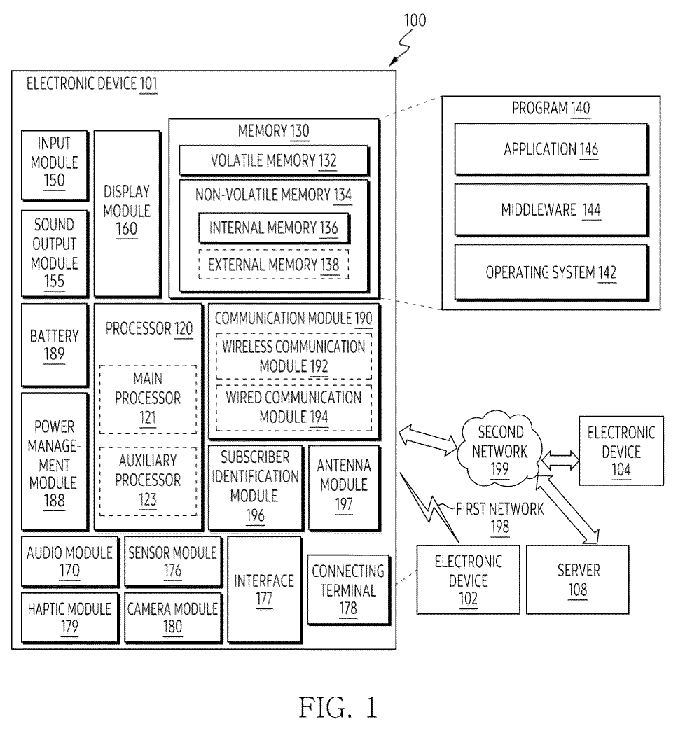

FIG. 1 is a block diagram illustrating an electronic device 101 in a network environment 100 according to one or more embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited to the above examples of artificial neural networks. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related to the software. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., through a wire) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., through a wire) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to one or more embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) between the above-described components via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 performs a function or a service automatically, or in response to (or based on) a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

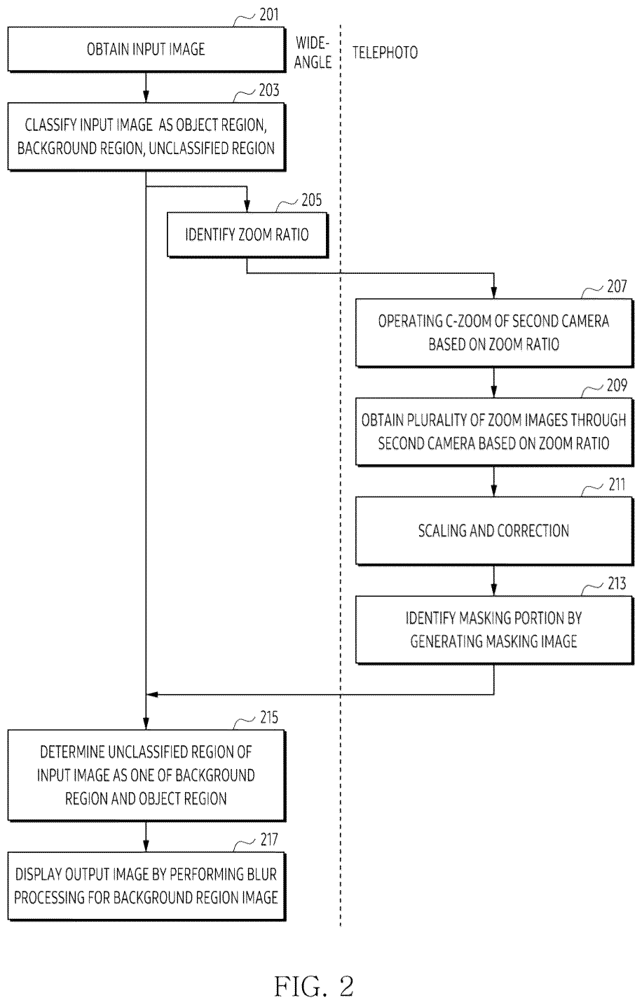

FIG. 2 is a flowchart of operations of an electronic device for classifying a background region and an object region, according to embodiments. The electronic device (e.g., the electronic device 101 of FIG. 1) may use continuous-zoom (c-zoom) to perform digital bokeh on an image.

Referring to FIG. 2, in operation 201, at least one processor (e.g., the processor 120 of FIG. 1) may obtain an input image. The input image may include an object corresponding to a subject. The input image may be obtained through a first camera. The first camera may be a wide-angle camera. However, the present disclosure are not limited to the above example embodiments. According to an embodiment, the first camera may be an ultrawide-angle camera. According to an embodiment, the first camera may be a telephoto camera. The input image may be obtained based on the first camera in which the continuous- zoom is not included. The at least one processor 120 may apply digital bokeh to the input image. The digital bokeh is a technology that synthesizes a blur-processed background region image with an object region image corresponding to the subject by separating the object region corresponding to the subject and the background region. A flow of an operation of the electronic device 101 for separating the background region image and the object region image is described below.

In operation 203, the at least one processor 120 may classify the input image as the object region, the background region, and an unclassified region (that may not be the object region nor the background region). The object region may be a portion of the image corresponding to the subject. The background region may be a portion of the image corresponding to a background. The background region may be a portion of the image corresponding to the background excluding a subject, which is farther than the subject. The unclassified region may be a portion of the image in which classification of whether it is the background region or the object region, with respect to the at least one processor, is unclear. For example, the unclassified region may include an object corresponding to a scattered hair. For example, the unclassified region may be a portion of the image corresponding to a space between fingers photographed while waving.

According to embodiments, the at least one processor 120 may classify the input image as the object region, the background region, and the unclassified region in various methods. According to an embodiment, the at least one processor 120 may detect a subject in the input image, and identify an outline of an object corresponding to the subject. The at least one processor 120 may identify the inside of the outline of the object corresponding to the subject as the object region, and the outside of the outline of the object corresponding to the subject as the background region. In a case that the outline of the object corresponding to the subject is unclear, the at least one processor 120 may identify a portion of the image corresponding to the unclear outline as the unclassified region.

According to an embodiment, the at least one processor 120 may identify a distance to target objects corresponding to objects in which the input image includes, through a ‘time-of-flight’ (TOF) sensor. When the distance to the target objects is less than a threshold distance, the at least one processor 120 may identify a corresponding target object as the subject. The at least one processor 120 may identify an outline of the object corresponding to the subject. The at least one processor 120 may identify a region inside the outline of the object corresponding to the subject as the object region. The at least one processor 120 may identify a region outside the outline of the object corresponding to the subject as the background region.

According to an embodiment, the at least one processor 120 may identify sharpness for each pixel of the input image. The sharpness may be an index for indicating how different a certain pixel is from a neighboring pixel. The sharpness may be determined based on a difference from the neighboring pixel. The at least one processor 120 may obtain the outline of the object by identifying a region in which its sharpness is different from sharpness of a neighboring portion. The at least one processor 120 may extract an outline with respect to an entire image. When the outline is clear, the region inside the outline may be identified as the object region. The at least one processor 120 may identify the region outside the outline of the object corresponding to the subject as the background region. However, according to embodiments of the present disclosure, a method of classifying a region of the input image is not limited to the above-described method.

In operation 205, the at least one processor 120 may identify a zoom ratio based on the unclassified region. The maximum value of the zoom ratio is the highest ratio among zoom images obtained by a second camera, and may be referred to as a zoom maximum ratio. The zoom maximum ratio may be the highest ratio that enables all zoom images obtained by the zoom ratio to include an image portion corresponding to the unclassified region. This may be because classification is easier since an image obtained by a camera with a higher focal length and a higher zoom ratio has a greater difference between the object region and the background region. The individual zoom ratio may be a zoom ratio corresponding to an individual image. The unclassified region may be included in the zoom image, so the at least one processor 120 may determine the unclassified region as one of the object region or the background region. The zoom ratio may be identified based on at least one of specification information of the first camera, specification information of the second camera, and specification information of the continuous-zoom (the c-zoom). For example, the at least one processor 120 may identify a zoom ratio corresponding to the first camera that may include the unclassified region included in the input image. The at least one processor 120 may identify the zoom ratio corresponding to the first camera as a zoom maximum ratio corresponding to the second camera and the c-zoom, based on a ratio of the first camera, a ratio of the second camera, and a ratio of the c-zoom. The at least one processor may enlarge the image by driving in hardware through the c-zoom.

In operation 207, the at least one processor 120 may perform continuous-zooming (c-zooming) by operating the continuous-zoom (the c-zoom) of the second camera based on the zoom ratio. The c-zoom may mean continuous-zoom. The c-zooming may be referred to as optical-zooming. The c-zooming may mean an operation of enlarging the image by actually driving zoom lens in hardware. The at least one processor 120 may obtain a plurality of zoom images having a different optical characteristic during zoom movement based on the c-zoom. The at least one processor 120 may obtain the plurality of zoom images through the c-zoom included in the second camera. The at least one processor 120 may obtain zoom images for each of a plurality of ratios from a certain ratio (i.e., a ratio of a starting point) up to the zoom ratio through the second camera. For example, if the zoom ratio is a 3× ratio, the at least one processor 120 may obtain a zoom image that is a 1× ratio, a zoom image that is a 1.5× ratio, a zoom image that is a 2× ratio, a zoom image that is a 2.5× ratio, and a zoom image that is a 3× ratio by the second camera including the c-zoom. The zoom images may be obtained based on the second camera including the c-zoom. The second camera may be a telephoto camera.

In operation 209, the at least one processor 120 may obtain the plurality of zoom images through the second camera based on the zoom ratio. In order to obtain a plurality of zoom images having different an individual zoom ratio, the at least one processor 120 may obtain the plurality of zoom images through the second camera including the c-zoom. In a case that the individual zoom ratio is different, a depth of the image may be different. As the individual zoom ratio is higher, the depth of the image may be shallower. The depth of an image may be a distance range at which the subject is perceived to be in focus when placed. The distance range may be between a front depth distance and a rear depth distance. The front depth distance may be shorter than the rear depth distance. The forward depth distance may be the shortest distance at which the subject is in focus when placed. The rear depth distance may be the farthest distance at which the subject is in focus when placed. The distance range may be a distance from the camera to the subject in focus. Since the depth of the image may be shallower as the individual zoom ratio is higher, the background region may appear blurred. Therefore, in the at least one processor 120, as the individual zoom ratio is higher, the depth may be shallower than when the individual zoom ratio is low. As the individual zoom ratio is higher, a degree of blur in the background may be greater. Therefore, the at least one processor 120 may easily classify the object region and the background region as the individual zoom ratio is higher. Each of the plurality of zoom images may have different depths and ratios.

In operation 211, the at least one processor 120 may perform scaling and correction. The at least one processor 120 may perform the scaling on the plurality of zoom images. The at least one processor 120 may identify a size of an object within a first zoom image corresponding to the zoom maximum ratio among the plurality of zoom images. The at least one processor 120 may perform the scaling on each of the plurality of zoom images other than the first zoom image based on the size of the object in the first zoom image.

According to an embodiment, since the plurality of zoom images have different individual zoom ratios, the size of the object corresponding to the subject may be different. The size of the object corresponding to the subject may be the largest in the first zoom image corresponding to the zoom maximum ratio. The at least one processor 120 may scale the size of the subject of each of zoom images equally, in order to generate a masking image based on the plurality of zoom images.

The at least one processor 120 may perform image rectification on the plurality of zoom images. The plurality of zoom images may have a different optical characteristic such as an angle of view, a ratio, and an optical axis and the like because the electronic device may shake while obtaining the plurality of zoom images. The at least one processor 120 may equally correct an image rectification characteristic of each zoom image, in order to generate the masking image based on the plurality of zoom images.

In operation 213, the at least one processor 120 may identify a masking portion by generating the masking image. For example, the at least one processor 120 may generate the plurality of masking candidate images based on the first zoom image and the scaled and image rectified second zoom images. The scaling and the image rectification may be referred to as an object matching process. The at least one processor 120 may generate the masking image in which the unclassified region is not included based on the plurality of masking candidate images. The at least one processor 120 may identify the masking portion corresponding to the object from the masking image.

According to an embodiment, the plurality of masking candidate images may be generated through a pixel-to-pixel ‘exclusive OR’ (XOR) operation in each of the first zoom image and the scaled second zoom images. The at least one processor 120 may designate a value corresponding to color of each pixel in zoom images (e.g., the first zoom image and the second zoom image). The at least one processor 120 may perform the XOR operation by comparing values of pixels disposed in the same coordinate in two zoom images (e.g., the first zoom image and the second zoom image). The at least one processor 120 may generate the masking candidate images by performing the XOR operation.

Even though individual zoom ratios between the zoom images are different, the object region in the zoom image finishing the scaling may be similar to an object region in another zoom image finishing the scaling. This may be because the subject corresponding to the object will be positioned at a distance shorter than the depth. In other words, since the subject corresponding to the object is positioned within the depth, there may be little difference in sharpness.

In the masking candidate image, the object region may mainly indicate a value of 0. Since the individual zoom ratio between the zoom images is different, the background region within the zoom image finishing the scaling may have a different degree of blur from a background region within the other zoom image finishing the scaling. This may be because a background object corresponding to the background region may be positioned at a distance farther than the depth. In other words, there may be a difference in the degree of blur between a case in which the background region is outside the depth and a case in which the background region is within the depth. Therefore, in the masking candidate image, the background region may mainly indicate a value of 1. According to an embodiment, the masking candidate image may be generated by comparing two zoom images. Therefore, masking candidate images from n zoom images up to ₙC₂ (2-combination or 2-combination) zoom images may be generated. According to an embodiment, the masking candidate image may be generated by comparing the first zoom image based on the zoom maximum ratio with the scaled second zoom images because classification between the object region and the background region may be easier since the depth is shallower as the zoom ratio is higher. Therefore, m (ₙC₂) masking candidate images may be generated from the n zoom images. However, the present disclosure are not limited to the above example embodiments.

According to an embodiment, the obtained masking image may be generated based on an average value of pixels in each of the plurality of masking candidate images. The at least one processor 120 may calculate an average value of pixels disposed in each coordinate based on values of pixels disposed in the same coordinate in the plurality of masking candidate images. The at least one processor 120 may display the average value for each pixel. The at least one processor 120 may classify a portion with a value less than a designated threshold value as a masking object region, and a portion with a value greater than or equal to the designated threshold value as a masking background region. The at least one processor 120 may generate a masking image including the masking object region and the masking background region.

According to an embodiment, a masking object region portion in the masking image may be the masking portion.

In operation 215, the at least one processor 120 may determine the unclassified region of the input image as one of the background region and the object region. The at least one processor 120 may compare the masking portion of the masking image with the unclassified region of the input image. The at least one processor 120 may correct the unclassified region of the input image. In the unclassified region correction, the at least one processor 120 may determine the unclassified region as one of the background region and the object region by comparing the masking portion with the unclassified region. Since the unclassified region is determined as one of the background region and the object region, the unclassified region may not be included in the input image after the correction of the unclassified region. In a case that the unclassified region of the input image overlaps the masking portion, the at least one processor 120 may determine the unclassified region of the input image as the object region. In a case that the unclassified region of the input image does not overlap the masking portion, the at least one processor 120 may determine the unclassified region of the input image as the background region.

In operation 217, the at least one processor 120 may display an output image by performing a blur processing for the background region image. The at least one processor 120 may perform the blur processing for the background region of the input image. The at least one processor 120 may generate the output image through a combination of the background region image on which the blur processing has been performed and the object region image corresponding to the masking portion.

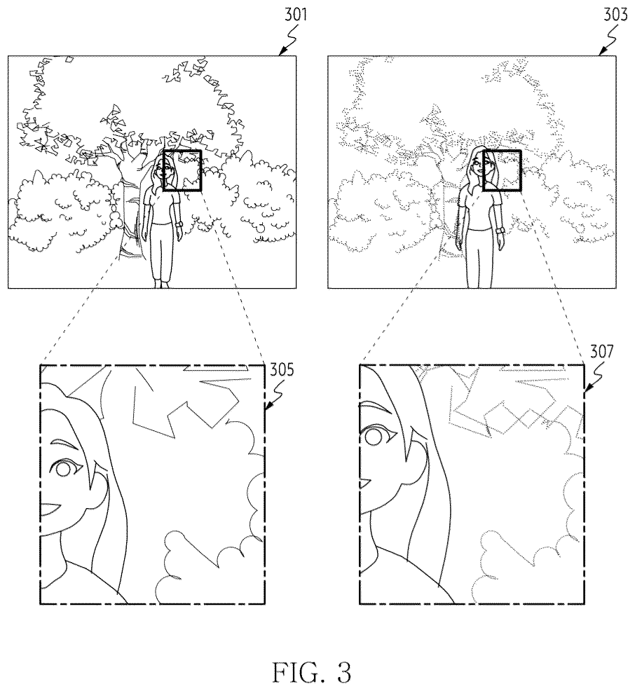

FIG. 3 illustrates an example of a change in a background region according to a zoom operation of a camera, according to embodiments.

Referring to FIG. 3, a first image 301 may be generated based on a first ratio. A second image 303 may be generated based on a second ratio. The first ratio may be smaller than the second ratio. An object region in a first image portion 305 may have similar sharpness to an object region in a second image portion 307. A background region in the first image portion 305 may have higher sharpness than a background region in the second image portion 307. Therefore, a region with a large difference for each pixel may be identified as the background region by comparing images (e.g., the first image 301 and the second image 303) with different ratios on a pixel-by-pixel basis. When comparing pixels of the images (e.g., the first image 301 and the second image 303) with the different ratios, in the object region, the difference for each pixel may be small. When comparing pixels of images (e.g., the first image 301 and the second image 303) with the different ratios, in the background region, the difference for each pixel may be larger than that of the object region.

The first image 301 may be obtained based on a low ratio zoom. Since the first image 301 is obtained based on a low ratio, a depth may be deep. Accordingly, the object region (e.g., a person) and the background region (e.g., a tree) in the first image 301 may appear relatively clearly. The second image 303 may be obtained based on a high ratio zoom. Since the second image 303 is obtained based on the high ratio zoom, the depth may be shallow. Thus, while the object region (e.g., a person) in the second image 303 is clear, the background region (e.g., a tree) in the second image 303 may appear blurred compared to the background region of the first image.

According to an embodiment, in case that an individual zoom ratio of images is different, a depth of the image may vary. As the individual zoom ratio is higher, the depth of the image may be shallower. The depth of the image may be a distance range at which it is recognized as being in focus. The distance range may be a distance from a camera to a focused subject. Since the depth of the image is shallower as the individual zoom ratio is higher, the background region may appear blurred. Therefore, as the individual zoom ratio is higher, the at least one processor 120 may easily classify the object region and the background region compared to when the individual zoom ratio is low. Each of the plurality of zoom images may have a different depth and ratio.

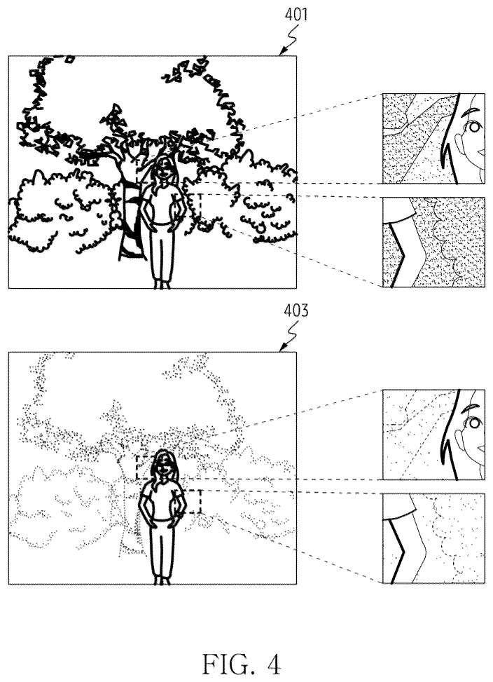

FIG. 4 illustrates an example of identification of an object region in accordance with a depth, according to embodiments.

Referring to FIG. 4, a first processed image 401 may be a processed first image (e.g., the first image 301 of FIG. 3). The first image 301 may be obtained based on a first camera having a first ratio. The first processed image 401 may be generated based on sharpness of the first image 301. The sharpness may be an index for indicating how different a certain pixel is from a neighboring pixel. A second processed image 403 may be a processed second image (e.g., the second image 303 of FIG. 3). The second image 303 may be obtained based on a second camera having a second ratio. The second processed image 403 may be generated based on sharpness of the second image 303. The first ratio may be smaller than the second ratio. For example, the first camera may be a wide-angle camera. As another example, the first camera may be an ultrawide-angle camera. For example, the second camera may be a telephoto camera. For example, the first ratio of the first camera may be a 1× ratio on the wide-angle camera. The second ratio of the second camera may be a 2× ratio on the telephoto camera.

According to an embodiment, the at least one processor 120 may identify sharpness for each pixel of an image (e.g., the first image 301 and the second image 303). The sharpness may be an index for indicating how different a certain pixel is from a neighboring pixel. The at least one processor 120 may obtain an outline of an object by identifying a region in which its sharpness is different from sharpness of a neighboring portion. The first image 301 generated based on a low ratio camera may have a deeper depth than the second image 303 generated based on a high ratio camera. In a case that the depth is deep, sharpness of the object region and a background region may increase. The depth of the second image 303 may be shallower than that of the first image 301. In a case that the depth is shallow, sharpness inside the background region may be lowered because the sharpness inside the background region is low. In a case that the depth is shallow, sharpness around the object region and the background region may increase. The object region may have high sharpness, and the background region may have low sharpness.

According to an embodiment, the first processed image 401 may be generated by processing the first image 301 through a nonlinear filter. The second processed image 403 may be generated by processing the second image 303 through the nonlinear filter. The depth of the first processed image 401 may be different from that of the second processed image 403. For example, a difference in sharpness may occur at a boundary between the object region and the background region. Since the first processed image 401 has a deep depth, high sharpness may be identified in both the object region and the background region. Since the second processed image 403 has a shallow depth, higher sharpness may be identified at the boundary around the object region than the background region.

For example, in the first processed image 401, when the background region inside an elbow of the person has high sharpness due to a high depth, a body part inside the elbow may be classified as the background region or an unclassified region. For example, in the first processed image 401, a portion in which a background region including a complex pattern (e.g., a region including pointed branches, and leaves) overlaps with an object region including a complex pattern (e.g., a collar of an elbow portion or a hair portion) may have a deep depth of the background region and the object region. The overlapping portion having the deep depth may be difficult to classify the object region and the background region based on the sharpness. However, in the second processed image 403, when the background portion inside the elbow of the person has low sharpness, the body part inside the elbow may be classified as the object region. For example, in the second processed image 403, in the overlapping portion, the depth of the background region and the object region may be shallow. The overlapping portion having the shallow depth may be advantageous to classify the object region from the background region based on the sharpness. In other words, a probability of the unclassified region occurring in the second processed image 403 may be reduced. In the unclassified region, classification may be ambiguous whether it is the object region or the background region, such as a face boundary of the person. In particular, since the wide-angle camera of an electronic device has deeper depth than the telephoto camera, a probability of identification of the unclassified region in the first image 301 obtained based on the wide-angle camera may be higher than in the second image 303 obtained based on the telephoto camera.

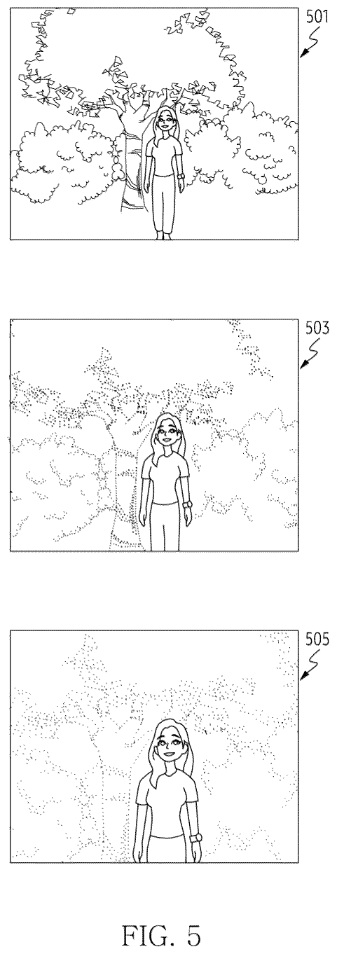

FIG. 5 illustrates an example of a depth according to a zoom operation of a camera, according to embodiments.

Referring to FIG. 5, a zoom image 501, a zoom image 503, and a zoom image 505 may be obtained through a second camera based on different zoom ratios. In order to obtain a plurality of zoom images (e.g., the zoom image 501, the zoom image 503, and the zoom image 505) having different an individual zoom ratio, the at least one processor 120 may obtain the plurality of zoom images (the zoom image 501, the zoom image 503, and the zoom image 505) through the second camera including a continuous-zoom. The at least one processor may enlarge an image by driving in hardware through the continuous-zoom (the c-zoom). In a case that the individual zoom ratio is different, a depth of the image may be different. As the individual zoom ratio is higher, the depth of the image may be shallower. The depth of the image may be a distance range at which it is recognized as being in focus. The distance range may be a distance from a camera to a focused subject. Since the depth of the image is shallower as the individual zoom ratio is higher, a background region may appear blurred. In other words, the background region may appear blurred in an order of the zoom image 501, the zoom image 503, and the zoom image 505. As the individual zoom ratio is higher, the at least one processor 120 may easily classify an object region and the background region compared to when the individual zoom ratio is low. The at least one processor 120 may easily classify the object region and the background region in the order of the zoom image 505, the zoom image 503, and the zoom image 501.

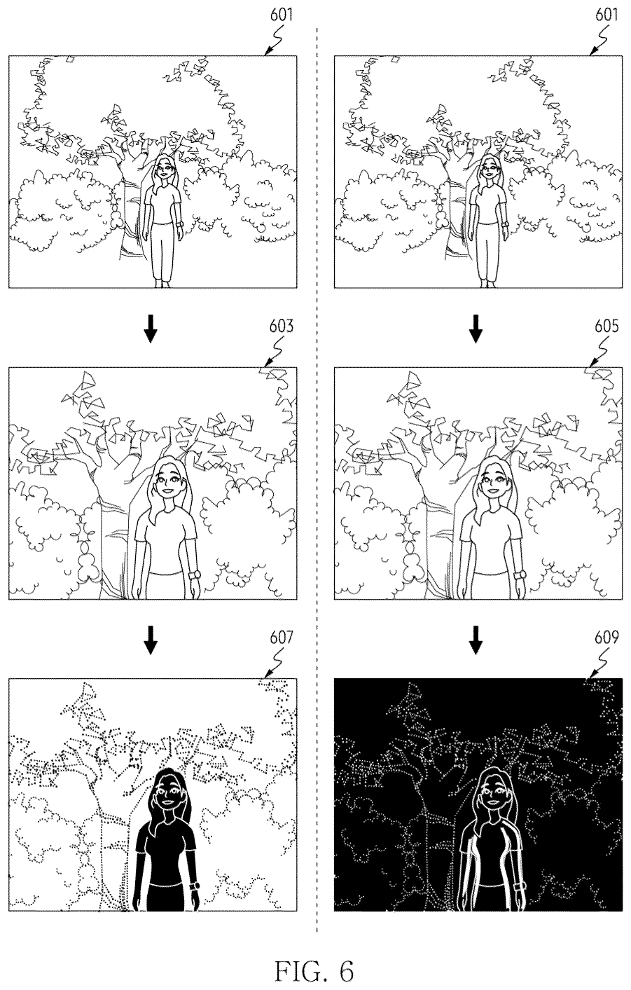

FIG. 6 illustrates an example of classifying an object region by discontinuous-zoom and classifying a region by continuous-zoom, according to embodiments.

Referring to FIG. 6, a first image 601 may be obtained through a first camera having a first ratio. For example, the first ratio may be a 1× ratio. A first enlarged image 603 may be obtained at a second ratio adjusted through the continuous-zoom. For example, the second ratio may be a 3× ratio. As the continuous-zoom (the c-zoom) is performed, an optical characteristic value (e.g., a focal length and a f-number) of a camera may be different compared to before the c-zooming is performed. The c-zooming may mean an operation of enlarging the image by actually driving zoom lens in hardware. The at least one processor may enlarge the image by driving in hardware through the c-zoom. The second enlarged image 605 may be obtained at the second ratio adjusted through digital-zoom (d-zoom). For example, the second ratio may be a 3× ratio. The at least one processor may enlarge the image by driving in software through the digital-zoom (the d-zoom). As d-zooming is performed, the optical characteristic value (e.g., the focal length and the f-number) of the camera may be maintained as before the d-zooming is performed. The d-zooming may be an operation of enlarging the image in software. A first comparison image 607 may indicate an XOR operation result between a pixel of a portion (e.g., an image in which the portion of the first image 601 is enlarged at 3×) enlarging the first image 601 and a pixel configuring the first enlarged image 603. A second comparison image 609 may indicate an XOR operation result between the pixel of the portion (e.g., the image in which the portion of the first image 601 is enlarged by three times) enlarging the first image 601 and a pixel configuring the second enlarged image 605.

According to an embodiment, an XOR operation is a data processing method that outputs 0 when each pixel bit value is the same and outputs 1 when each pixel bit value is different. The at least one processor 120 may designate a value corresponding to color of each pixel in the images (e.g., the first image 601, the first enlarged image 603, and the second enlarged image 605). The at least one processor 120 may perform the XOR operation between a pixel configuring the first image 601 and the pixel configuring the first enlarged image 603. The at least one processor 120 may perform the XOR operation between the pixel configuring the first image 601 and the pixel configuring the second enlarged image 605. In the first comparison image 607 and the second comparison image 609, the at least one processor 120 may represent a value whose an operation result is close to 0 as dark, a value close to the pixel maximum value 255 as white, and may represent 1 in case that it is greater than or equal to a threshold value based on a certain threshold value, and 0 in case that it is less than the threshold value.

According to an embodiment, referring to the first comparison image 607, a difference between an object region of the first image 601 and an object region of the first enlarged image 603 may be smaller than a difference between a background region of the first image 601 and a background region of the first enlarged image 603. The object region may be a portion of the image in focus. The large difference between pixels in the background region may be due to a difference in depth and perspective projection distortion according to the continuous-zooming (the c-zooming). The c-zooming may be referred to as optical-zooming. The c-zooming may mean an operation of enlarging the image by actually driving a zoom lens in hardware.

According to an embodiment, referring to the second comparison image 609, there may be little difference between the first image 601 and the second enlarged image 605 because a portion of the second comparison image 609 appears mostly as black. According to an embodiment, it may be difficult to identify the object region and the background region through the digital-zoom (the d-zoom) because there is no phenomenon in which the background image is blurred during the d-zooming. The at least one processor may enlarge the image by driving in software through the digital-zoom (the d-zoom). The d-zooming may be an operation of enlarging the image in software. The at least one processor may identify the object region and the background region in an image through the continuous-zoom (the c-zoom) because a phenomenon in which the background image is blurred occurs during the continuous-zooming (the c-zooming). The c-zooming may be an operation of enlarging the image by actually driving the zoom lens in hardware.

According to an embodiment, the depth may be changed according to a focal length and a f-number of the camera lens, a size of a cell of a sensor (e.g., a charge-coupled device (CCD)) and a distance between a subject and the camera. During the continuous-zooming (the c-zooming), the focal length and the f-number of the camera lens may be changed. Therefore, during the c-zooming, the depth may be changed. During the digital-zooming, the focal length and the f-number of the camera lens may be maintained. Therefore, during the d- zooming, the depth may be maintained.

According to an embodiment, in order to obtain the plurality of zoom images having a different individual zoom ratio, the at least one processor 120 may obtain the plurality of zoom images through the second camera including the continuous-zoom (the c-zoom). The at least one processor 120 may generate masking candidate images based on the plurality of zoom images.

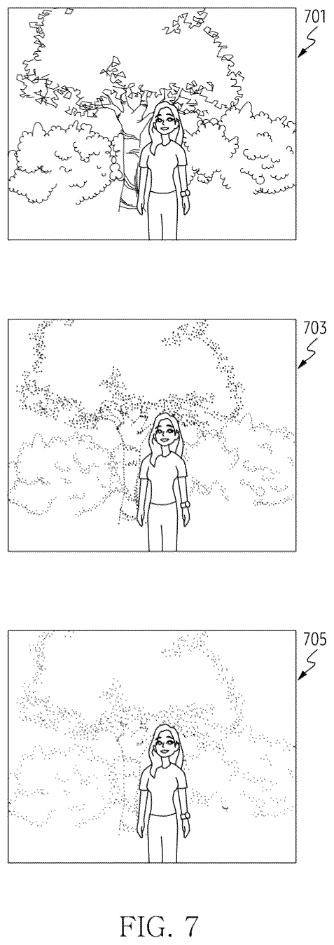

FIG. 7 illustrates an example of scaling performed based on a size of an object.

Referring to FIG. 7, corrected zoom image 701, corrected zoom image 703, and corrected zoom image 705 may be generated by performing scaling and slope correction on images obtained through a second camera based on different zoom ratios. The scaling and the slope correction may be referred to as an object matching processing. As an individual zoom ratio is higher, a depth of an image may be shallower. The depth of the image may be a distance range at which it is recognized as being in focus. Since the depth of the image is shallower as the individual zoom ratio is higher, a background region may appear blurred. In other words, the background region may appear blurred in an order of the corrected zoom image 705, the corrected zoom image 703, and the corrected zoom image 701.

According to an embodiment, the at least one processor 120 may perform the scaling on the plurality of zoom images. The at least one processor 120 may identify a size of an object in a first zoom image corresponding to the zoom ratio among the plurality of zoom images. The at least one processor 120 may perform the scaling on each of the plurality of zoom images other than the first zoom image based on the size of the object in the first zoom image.

According to an embodiment, since the plurality of zoom images a different individual zoom ratio, a size of an object corresponding to a subject may be different. The size of the object corresponding to the subject may be the largest in the first zoom image corresponding to the maximum zoom ratio. The at least one processor 120 may scale the size of the subject of each zoom image equally to generate a masking image based on the plurality of zoom images.

The at least one processor 120 may perform the slope correction on the plurality of zoom images. The scaling and the slope correction may be referred to as the object matching processing. The plurality of zoom images may have different slopes because an electronic device may shake while obtaining the plurality of zoom images. The at least one processor 120 may equally correct the slope of each zoom image to generate the masking image based on the plurality of zoom images.

According to an embodiment, the corrected image 701, the corrected image 703, and the corrected image 705 scaled and slope-corrected based on the size of the subject may be used for an operation for removing an unclassified region in an input image.

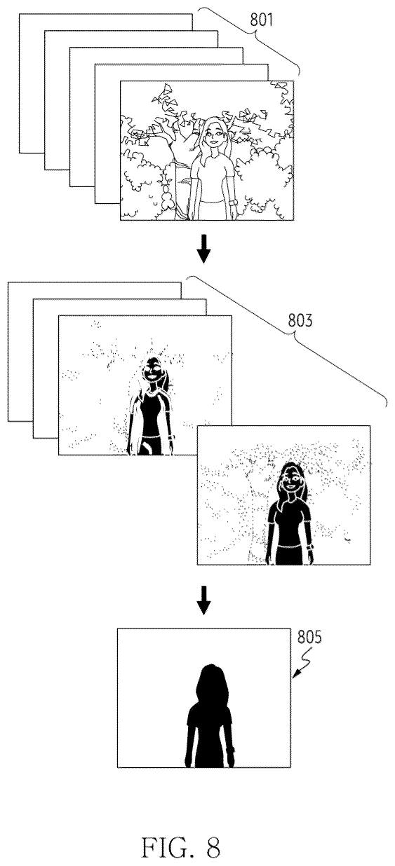

FIG. 8 illustrates an example of a method of generating a masking image based on a plurality of zoom images.

Referring to FIG. 8, a plurality of scaled and corrected zoom images 801 may be generated by scaling and correcting images obtained through a second camera including continuous-zoom (c-zoom). The at least one processor may enlarge an image by driving in hardware through the continuous-zoom (the c-zoom). The number of the plurality of zoom images 801 may be n. A plurality of masking candidate images 803 may be generated based on the corrected plurality of zoom images 801. The number of the plurality of masking candidate images 803 may be m. A masking image 805 may be generated based on the plurality of masking candidate images 803.

According to an embodiment, a process of generating the masking candidate images 803 based on the corrected plurality of zoom images 801 may be performed to increase accuracy of classifying between an object region corresponding to a subject such as hair in an unclassified region and a background region. In addition, the process may be performed to remove a movement element when there is movement in a background.

According to an embodiment, m masking candidate images 803 may be generated based on the n corrected plurality of zoom images 801. Each of the n corrected plurality of zoom images 801 may be generated through a pixel-to-pixel XOR operation. The ‘exclusive OR’ (XOR) operation may be a data processing method that outputs 0 when two input values are the same and outputs 1 when two input values are different. The XOR operation may be processed in units of pixel bits. However, the present disclosure is not limited to the above example embodiments. According to an embodiment, the at least one processor may use the XOR operation, which is advantageous for shortening operation time, in order to obtain a difference between videos. According to another embodiment, the at least one processor may obtain a difference between videos using a conventional technique other than the XOR operation. The at least one processor 120 may designate a value corresponding to color of each pixel in zoom images. The at least one processor 120 may perform the XOR operation by comparing values of pixels disposed in the same coordinate in the two zoom images. The at least one processor 120 may generate masking candidate images by performing the XOR operation.

In the masking candidate image, the object region may mainly indicate a value of 0. Since an individual zoom ratio between the zoom images is different, a background region within the scaled zoom image may have a different degree of blur from a background region within another scaled zoom image. This may be because a background object corresponding to the background region may be positioned at a distance farther than a depth. Therefore, in the masking candidate image, the object region may mainly indicate a value of 0. According to an embodiment, the masking candidate image may be generated by comparing two zoom images. Therefore, the masking candidate images from the n zoom images up to ₙC₂ (2-combination or 2-combination) images may be generated. m may be a maximum of ₙC₂ (2-combination, or 2-combination). According to an embodiment, the masking candidate image may be generated by comparing a first zoom image based on the maximum zoom ratio with scaled second zoom images because classification between the object region and the background region may be easier since the depth is shallower as the zoom ratio is higher.

According to an embodiment, the obtained masking image 805 may be generated based on an average value of pixels in each of the plurality of masking candidate images 803. The at least one processor 120 may identify an average value of pixels disposed in each coordinate based on values of pixels disposed in the same coordinate in the plurality of masking candidate images 803. The at least one processor 120 may display the average value for each pixel. The at least one processor 120 may classify a portion in which the average value is less than a designated threshold value as a masking object region, and a portion in which the average value is greater than or equal to the designated threshold value as a masking background region. The at least one processor 120 may generate the masking image 805 including the masking object region and the masking background region. Through the method, the masking image 805 having no unclassified region may be generated. The masking candidate image including a plurality of unclassified region may identify the unclassified region portion as one of the object region and the background region through a plurality of candidate images not including the unclassified region.

According to an embodiment, the object region and the background region may be identified and separated from the masking image 805. The separated object region may be a masking portion.

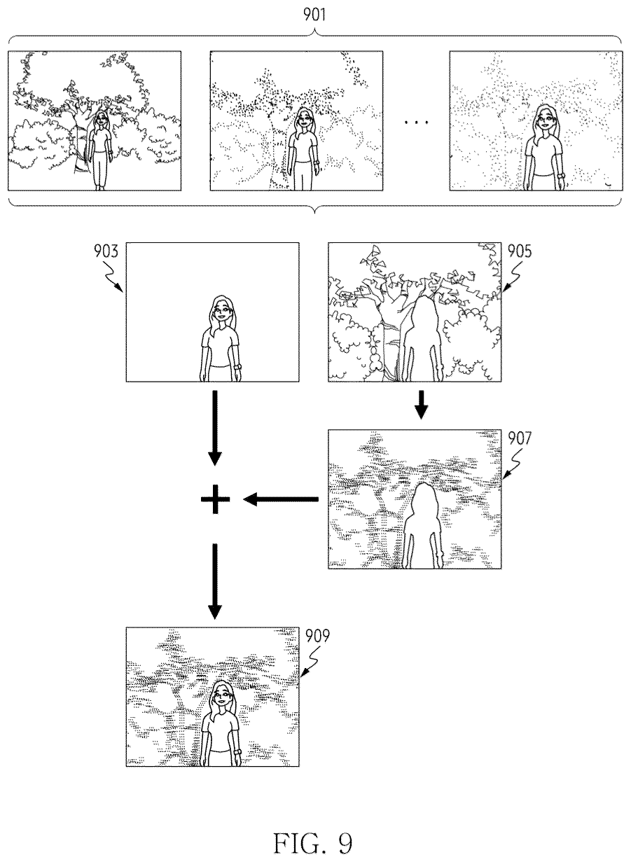

FIG. 9 illustrates an example of a method of generating an output image based on a plurality of zoom images.

Referring to FIG. 9, a plurality of zoom images 901 may be obtained through a second camera including c-zoom based on a zoom ratio. The at least one processor may enlarge an image by driving in hardware through the c-zoom.

According to an embodiment, in order to obtain a plurality of zoom images having a different individual zoom ratio, the at least one processor 120 may obtain a plurality of zoom images through a second camera including the continuous-zoom (the c-zoom). The second camera may be a telephoto camera including the c-zoom. The number of the plurality of zoom images 901 may be n.

According to an embodiment, the at least one processor 120 may perform scaling and slope correction processing on the plurality of zoom images 901. The scaling and the slope correction may be referred to as an object matching processing. The at least one processor 120 may generate a plurality of masking candidate images based on the plurality of zoom images 901 subjected to the scaling and the slope correction. The masking candidate images may be generated by an XOR operation.

According to an embodiment, the at least one processor 120 may generate a masking image based on the masking candidate images. For example, by identifying an average value for each pixel, the masking image may be generated based on the identified average value for each pixel.

According to an embodiment, the at least one processor 120 may identify an object region and a background region of the masking image. The object region of the masking image may be referred to as a masking portion.

According to an embodiment, the at least one processor 120 may divide an input image obtained through a first camera (e.g., a wide-angle camera) into an object region 903 and a background region 905 based on the masking portion.

The at least one processor 120 may perform a blur processing for the image of the background region 905 for a digital bokeh effect. The at least one processor 120 may generate an output image 909 by combining a blurred background region 907 with the object region 903. The output image 909 may be an image on which digital bokeh has been performed. The image of the object region 903 may be a region of interest (ROI).

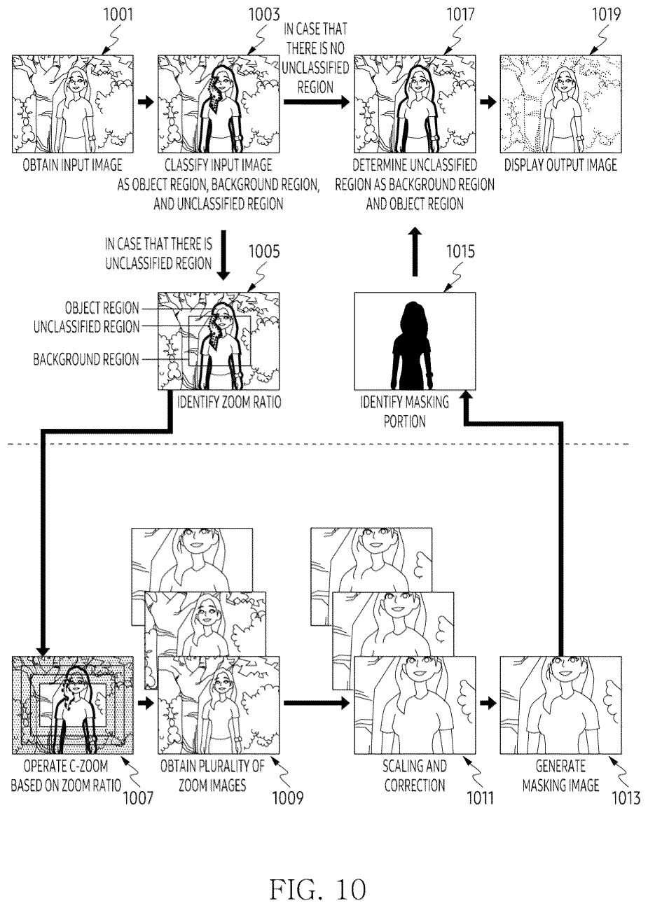

FIG. 10 illustrates a flow of operations of an electronic device for generating an output image to which digital bokeh is applied through continuous-zoom.

Referring to FIG. 10, in operation 1001, the at least one processor 120 may obtain an input image. The input image may include an object corresponding to a subject. The input image may be obtained through a first camera. The first camera may be a wide-angle camera. However, embodiments of the present disclosure are not limited to the above example embodiments.

In operation 1003, the at least one processor 120 may classify the input image as an object region, a background region, and an unclassified region. The object region may be an image portion corresponding to the subject. The background region may be a portion of the image corresponding to a background. The background region may be a portion of the image excluding a subject farther from the subject. The unclassified region may be a portion of the image in which classification of whether it is the background region or the object region, with respect to the at least one processor 120, is unclear. For example, the unclassified region may include an object corresponding to a scattered hair. The at least one processor 120 may perform operation 1017 when there is no unclassified region in the image. The at least one processor 120 may perform operation 1015 when there is the unclassified region in the image.

In operation 1005, the at least one processor 120 may identify a zoom ratio based on an image portion corresponding to the unclassified region. The maximum value of the zoom ratio is the highest ratio among zoom images obtained by a second camera, and may be referred to as a zoom maximum ratio. The zoom maximum ratio may be the highest ratio that enables all zoom images obtained by the zoom ratio to include the image portion corresponding to the unclassified region.

In operation 1007, the at least one processor 120 may operate continuous-zoom (c-zoom) of the second camera based on the zoom ratio. The c-zoom may mean continuous zoom. The at least one processor may enlarge the image by driving in hardware through the c-zoom. The at least one processor 120 may obtain a plurality of zoom images having a different optical characteristic during zoom movement based on the c-zoom. The at least one processor 120 may obtain the plurality of zoom images through the c-zoom included in the second camera.

In operation 1009, the at least one processor 120 may obtain the plurality of zoom images through the second camera based on the zoom ratio. In order to obtain the plurality of zoom images having a different individual zoom ratio, the at least one processor 120 may obtain the plurality of zoom images through the second camera including the c-zoom.

In operation 1011, the at least one processor 120 may perform scaling and correction. The at least one processor 120 may perform the scaling on the plurality of zoom images. The at least one processor 120 may perform the scaling on each of the plurality of zoom images other than a first zoom image based on a size of an object in the first zoom image.

The at least one processor 120 may perform slope correction on the plurality of zoom images because the electronic device may shake while obtaining the plurality of zoom images. The at least one processor 120 may equally correct a slope of each zoom image to generate a masking image based on the plurality of zoom images.

In operation 1013, the at least one processor 120 may generate a masking image to identify a masking portion. According to an embodiment, the plurality of masking candidate images may be generated through a pixel-to-pixel XOR operation in each of the first zoom image and scaled second zoom images. According to an embodiment, the obtained masking image may be generated based on an average value of pixels in each of the plurality of masking candidate images. The at least one processor 120 may calculate an average value of pixels disposed in each coordinate based on values of pixels disposed in the same coordinate in the plurality of masking candidate images.

In the operation 1015, the at least one processor 120 may identify a masking portion. According to an embodiment, a masking object region portion in the masking image may be the masking portion.

In the operation 1017, the at least one processor 120 may determine the unclassified region of the input image as one of the background region and the object region. The at least one processor 120 may compare the masking portion of the masking image with the unclassified region of the input image. The at least one processor 120 may correct the unclassified region of the input image. In the unclassified region correction, the at least one processor 120 may determine the unclassified region as one of the background region and the object region by comparing the masking portion with the unclassified region. Since the unclassified region is determined as one of the background region and the object region, the unclassified region may not be included in the input image after the unclassified region correction.

In operation 1019, the at least one processor 120 may display an output image by performing a blur processing for a background region image. The at least one processor 120 may perform the blur processing for the background region of the input image. The at least one processor 120 may generate the output image through a combination of the background region image on which the blur processing has been performed and the object region image corresponding to the masking portion.

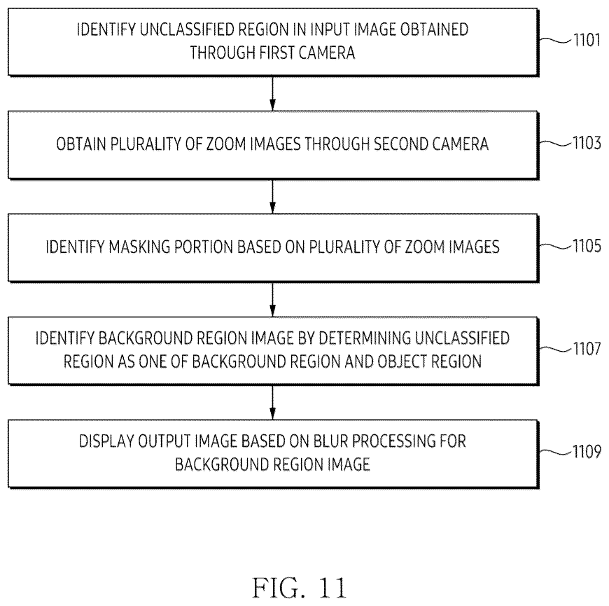

FIG. 11 illustrates a flow of operations of an electronic device for performing digital bokeh.

Referring to FIG. 11, in operation 1101, the at least one processor may identify an unclassified region in an input image obtained through a first camera. The at least one processor 120 may obtain the input image. The input image may include an object corresponding to a subject. The input image may be obtained through the first camera. The at least one processor 120 may classify the input image as an object region, a background region, and an unclassified region. The object region may be an image portion corresponding to the subject. The background region may be a portion of the image corresponding to a background. The unclassified region may be a portion of the image in which classification of whether it is the background region or the object region, with respect to the at least one processor 120, is unclear.

In operation 1103, the at least one processor 120 may obtain a plurality of zoom images through a second camera. The at least one processor 120 may identify a zoom ratio based on an image portion corresponding to the unclassified region. The zoom ratio may be the highest ratio among the zoom images obtained by the second camera. The at least one processor 120 may obtain the plurality of zoom images through the second camera based on the zoom ratio. The continuous-zoom (the c-zoom) may mean continuous zoom.

In operation 1105, the at least one processor 120 may identify a masking portion based on the plurality of zoom images. The at least one processor 120 may perform at least one of scaling and correction. The at least one processor 120 may perform the scaling on the plurality of zoom images because a size of objects included in the plurality of zoom images may be different. The at least one processor 120 may perform slope correction on the plurality of zoom images because the electronic device may shake while obtaining the plurality of zoom images.

According to an embodiment, the at least one processor 120 may generate a plurality of masking candidate images based on the plurality of zoom images. For example, the plurality of masking candidate images may be generated through a pixel-to-pixel XOR operation in each of a first zoom image and scaled second zoom images. According to an embodiment, the at least one processor 120 may generate a masking image from the plurality of masking candidate images. For example, the obtained masking image may be generated based on an average value of pixels in each of the plurality of masking candidate images. According to an embodiment, the at least one processor 120 may identify a masking portion. For example, a masking object region portion in the masking image may be the masking portion.

In operation 1107, the at least one processor 120 may identify a background region image by determining the unclassified region as one of the background region and the object region. The at least one processor 120 may compare the masking portion of the masking image with the unclassified region of the input image. The at least one processor 120 may correct the unclassified region of the input image. In the unclassified region correction, the at least one processor 120 may determine the unclassified region as one of the background region and the object region by comparing the masking portion with the unclassified region. Since the unclassified region is determined as one of the background region and the object region, the unclassified region may not be included in the input image after the correction of the unclassified region.

In operation 1109, the at least one processor 120 may display an output image based on a blur processing for the background region image. The at least one processor 120 may perform the blur processing for the background region of the input image. The at least one processor 120 may generate the output image through a combination of the background region image on which the blur processing has been performed and the object region image corresponding to the masking portion.

As described above, an electronic device 101 according to an embodiment may comprise a first camera 180, a second camera 180, a display 160, and at least one processor 120. A focal length of the second camera 180 may be different from a focal length of the first camera 180. The at least one processor 120 may be configured to identify, within an input image obtained through the first camera 180, an unclassified region that is neither identified as an object region nor as a background region. The at least one processor 120 may be configured to obtain, through the second camera 180, a plurality of zoom images 801 and 901 based on a zoom ratio of the second camera 180 identified, by the at least one processor 120, to include (or capture) the unclassified region. The at least one processor 120 may be configured to identify a masking portion corresponding to an object based on the plurality of zoom images 801 and 901. The at least one processor 120 may be configured to identify a background region image of the input image by determining the unclassified region as one of the background region and the object region based on the input image and the masking portion. The at least one processor 120 may be configured to display an output image 909 through the display 160 based on a blur processing for the background region image.

The at least one processor 120 according to an embodiment may be, to obtain the plurality of zoom images 801 and 901, configured to obtain, through the second camera 180, a zoom image for each of a plurality of ratios from a certain ratio (i.e., a ratio of a starting point) up to the zoom ratio.

The at least one processor 120 according to an embodiment may be, to identify the masking portion, configured to identify a size of an object within a first zoom image among the plurality of zoom images 801 and 901 corresponding to the zoom ratio. The at least one processor 120 may be, to identify the masking portion, configured to perform scaling on each of the other zoom images (second zoom images) 801 and 901, different from the first zoom image, among the plurality of zoom images 801 and 901, based on the size of the object in the first zoom image.

The at least one processor 120 according to an embodiment may be, to identify the masking portion, configured to generate a plurality of masking candidate images 803 based on the first zoom image and the scaled second zoom images 801 and 901. The at least one processor 120 may be, to identify the masking portion, configured to generate a masking image 805 in which the unclassified region is not included, based on the plurality of masking candidate images 803. The at least one processor 120 may be, to identify the masking portion, configured to identify the masking portion corresponding to the object from the masking image 805.

The plurality of masking candidate images 803 according to an embodiment may be generated through a pixel-to-pixel XOR operation performed on each of the plurality of zoom images 801 and 901.

The masking image 805 according to an embodiment may be generated based on an average value of pixels of each of the plurality of masking candidate images 803.

The at least one processor 120 according to an embodiment may be, to identify the background region image, configured to, in a case that the unclassified region of the input image overlaps with the masking portion, determine the unclassified region of the input image as the object region. The at least one processor 120 according to an embodiment may be, to identify the background region image, configured to, in a case that the unclassified region of the input image does not overlap with the masking portion, determine the unclassified region of the input image as the background region.

The output image 909 according to an embodiment may be generated by combining the background region image subjected to the blur processing with an object region image corresponding to the masking portion.

Each of the plurality of zoom images 801 and 901 according to an embodiment may have a different depth and ratio.

The first camera 180 according to an embodiment may be a camera without continuous zoom. The second camera 180 may be a telephoto camera including continuous zoom.

As described above, a method performed by an electronic device according to an embodiment may comprise identifying, within an input image obtained through a first camera 180, an unclassified region that is neither identified as an object region nor as a background region. The method may comprise obtaining, through a second camera 180, a plurality of zoom images 801 and 901 based on a zoom ratio of the second camera 180 identified to include the unclassified region. The method may comprise identifying a masking portion corresponding to an object based on the plurality of zoom images 801 and 901. The method may comprise identifying a background region image of the input image by determining the unclassified region as one of the background region and the object region based on the input image and the masking portion. The method may comprise displaying an output image 909 through a display 160 based on a blur processing for the background region image.

According to an embodiment, the obtaining the plurality of zoom images 801 and 901 may comprise obtaining, through the second camera 180, a zoom image for each of a plurality of ratios from a certain ratio (i.e., a ratio of a starting point) up to the zoom ratio.

According to an embodiment, the identifying the masking portion may comprise identifying a size of an object within a first zoom image among the plurality of zoom images 801 and 901 corresponding to the zoom ratio. The identifying the masking portion may comprise performing scaling on each of the other zoom images (the second zoom images) 801 and 901, different from the first zoom image, among the plurality of zoom images 801 and 901 based on the size of the object in the first zoom image.

According to an embodiment, the identifying the masking portion may comprise generating a plurality of masking candidate images 803 based on the first zoom image and the scaled second zoom images 801 and 901. The identifying the masking portion may comprise generating a masking image 805 in which the unclassified region is not included, based on the plurality of masking candidate images 803. The identifying the masking portion may comprise identifying the masking portion corresponding to the object from the masking image 805.

According to an embodiment, each of the plurality of masking candidate images 803 may be generated through a pixel-to-pixel XOR operation performed on each of the plurality of zoom images 801 and 901.

According to an embodiment, the masking image 805 may be generated based on an average value of pixels of each of the plurality of masking candidate images 803.

According to an embodiment, the identifying the background region image may comprise, in a case that the unclassified region of the input image overlaps with the masking portion, determining the unclassified region of the input image as the object region. The identifying the background region image may comprise, in a case that the unclassified region of the input image does not overlap with the masking portion, determining the unclassified region of the input image as the background region.

According to an embodiment, the output image 909 may be generated by combining the background region image subjected to the blur processing with an object region image corresponding to the masking portion.

According to an embodiment, each of the plurality of zoom images 801 and 901 may have a different depth and ratio.

According to an embodiment, the first camera 180 may be a camera without continuous zoom. The second camera 180 may be a telephoto camera including continuous zoom.

The electronic device according to one or more embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

One or more embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. A singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). If an element (e.g., a first element) is referred to, with or without the term “operatively” or “communicatively”, as “coupled with,” or “connected with” another element (e.g., a second element), the element may be coupled with the other element directly (e.g., through a wire), wirelessly, or via a third element.

As used in connection with one or more embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

One or more embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine- readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to one or more embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities, and some of the multiple entities may be separately disposed in different components. According to one or more embodiments, one or more of the above-described components may be omitted, or one or more other components may be added. Alternatively or additionally, a plurality of components (e.g., modules or programs) may be integrated into a single component. In such a case, according to one or more embodiments, the integrated component may still perform one or more functions of each of the plurality of components in the same or similar manner as they are performed by a corresponding one of the plurality of components before the integration. According to one or more embodiments. operations performed by the module. the program, or another component may be carried out sequentially, in parallel, repeatedly, or heuristically, or one or more of the operations may be executed in a different order or omitted. or one or more other operations may be added.

What is claimed is:

1. An electronic device comprising:
a first camera having a first focal length;
a second camera having a second focal length that is different from the first focal length of the first camera;
a display; and
at least one processor operatively connected to the first camera, the second camera, and the display; and
memory storing instructions, when executed by the at least one processor, cause the electronic device to:
identify, within an input image obtained through the first camera, an unclassified region that is neither identified as an object region nor as a background region;
obtain, through the second camera, a plurality of zoom images based on a zoom ratio of the second camera identified to include the unclassified region;
identify a masking portion corresponding to an object, based on the plurality of zoom images;
identify a background region image of the input image by determining the unclassified region as one of the background region and the object region based on the input image and the masking portion; and
display, through the display, an output image based on a blur processing for the background region image.

2. The electronic device of claim 1, wherein the instructions, when executed by the at least one processor, cause the electronic device to obtain the plurality of zoom images by obtaining, through the second camera, a zoom image for each of a plurality of ratios from a ratio of a starting point up to the zoom ratio.

3. The electronic device of claim 1, the instructions, when executed by the at least one processor, cause the electronic device to identify the masking portion by:
identifying a size of the object within a first zoom image, among the plurality of zoom images, corresponding to the zoom ratio, and
performing scaling on each of second zoom images that are different from the first zoom image, among the plurality of zoom images, based on the size of the object in the first zoom image.

4. The electronic device of claim 3, wherein the instructions, when executed by the at least one processor, cause the electronic device to identify the masking portion by:
generating a plurality of masking candidate images, based on the first zoom image and the scaled second zoom images,
generating a masking image in which the unclassified region is not included, based on the plurality of masking candidate images, and
identifying the masking portion corresponding to the object from the masking image.

5. The electronic device of claim 3, wherein each of the plurality of masking candidate images is generated through a pixel-to-pixel exclusive OR (XOR) operation performed on each of the plurality of zoom images.

6. The electronic device of claim 4, wherein the masking image is generated based on an average value of pixels of each of the plurality of masking candidate images.

7. The electronic device of claim 1, wherein the instructions, when executed by the at least one processor, cause the electronic device to identify the background region image by:
in a first case that the unclassified region of the input image overlaps with the masking portion, determining the unclassified region of the input image as the object region, and
in a second case that the unclassified region of the input image does not overlap with the masking portion, determining the unclassified region of the input image as the background region.

8. The electronic device of claim 1, wherein the output image is generated by combining the background region image subjected to the blur processing with an object region image corresponding to the masking portion.

9. The electronic device of claim 1, wherein each of the plurality of zoom images has a different depth and ratio.

10. The electronic device of claim 1, wherein the first camera is a camera without continuous zoom, and
wherein the second camera is a telephoto camera having the continuous zoom.

11. A method performed by an electronic device, the method comprising:
identifying, within an input image obtained through a first camera of the electronic device, an unclassified region that is neither identified as an object region nor as a background region;
obtaining, through a second camera of the electronic device, a plurality of zoom images based on a zoom ratio of the second camera identified to include the unclassified region;
identifying a masking portion corresponding to an object, based on the plurality of zoom images;
identifying a background region image of the input image by determining the unclassified region as one of the background region and the object region, based on the input image and the masking portion; and
displaying, through a display of the electronic device, an output image based on a blur processing for the background region image.

12. The method of claim 11, wherein the obtaining the plurality of zoom images comprises obtaining, through the second camera, a zoom image for each of a plurality of ratios from a ratio of a starting point to the zoom ratio.

13. The method of claim 11, wherein the identifying the masking portion comprises:
identifying a size of the object within a first zoom image, among the plurality of zoom images, corresponding to the zoom ratio, and
performing scaling on each of second zoom images that are different from the first zoom image, among the plurality of zoom images, based on the size of the object in the first zoom image.

14. The method of claim 13, wherein the identifying the masking portion comprises:
generating a plurality of masking candidate images, based on the first zoom image and the scaled second zoom images,
generating a masking image in which the unclassified region is not included, based on the plurality of masking candidate images, and
identifying the masking portion corresponding to the object from the masking image.

15. The method of claim 11, wherein each of the plurality of masking candidate images is generated through a pixel-to-pixel exclusive OR (XOR) operation performed on each of the plurality of zoom images.
